(19) United States
(12) Patent Application Publication
(10) Pub. No.: US 2007/0110911 A1
(43) Pub. Date: May 17, 2007

(54) Spray coating device

(76) Inventor: Peter Steiger, Haeggenschwil (CH)

Correspondence Address: LOWE, HAUPTMAN, GILMAN & BERNER, LLP (ITW), 1700 DIAGONAL ROAD, SUITE 300, ALEXANDRIA, VA, 22314, US

(21) Appl. No.: 10/581,065

(22) PCT Filed: Dec. 15, 2004
(86) PCT No.: PCT/IB04/01415

§ 371 Date: May 30, 2006

(30) Foreign Application Priority Data
Dec. 17, 2003 (DE) 103 59 280.6

(51) Int. Cl. B05D 1/02; B05B 13/04; B05C 5/00; B05B 13/02

(52) U.S. Cl. 427/424; 118/320; 118/322; 118/323; 427/427.3; 427/425

(57) ABSTRACT

Spraycoating apparatus to spraycoat front/rear sides (16) of circular objects, in particular the front sides (16) of wheels and rims (4) that are being moved by a conveyor (2). Spray devices (80, 81) are rotatable to and fro in arcuate manner and eccentrically to a drive axis of rotation (66). The drive axis of rotation (66) and the center axis (14) of the objects (4) are aligned with each other.

The present invention relates to a spray coating device, hereafter spraycoating apparatus, defined in the preamble of claim 1 and a to a spraying method to spraycoat the front/rear sides of circular objects with coating material.

These circular objects illustratively are arbitrary wheels and vehicle wheel rims. In particular the present invention relates not only to coating the front (outer) sides of wheels and rims. Wheels and rims require substantially higher coating quality and coating life at their outer sides than at their rear sides.

The coating material may be liquid coating, in particular varnish, or preferably it may be coating powder.

State of the Art

U.S. Pat. No. 4,357,900 shows a spraycoating apparatus automatically controlling spraycoating in particular with coating powder.

Spray devices may be spray heads or spray guns fitted with a sprayhead at their front end. The coating material spray head may comprise a spray nozzle or a rotary element. Spray devices comprising a rotary element comminuting coating powder is known from U.S. Pat. No. 5,353,995. Moreover rotary elements atomizing liquid coating materials are known in the state of the art.

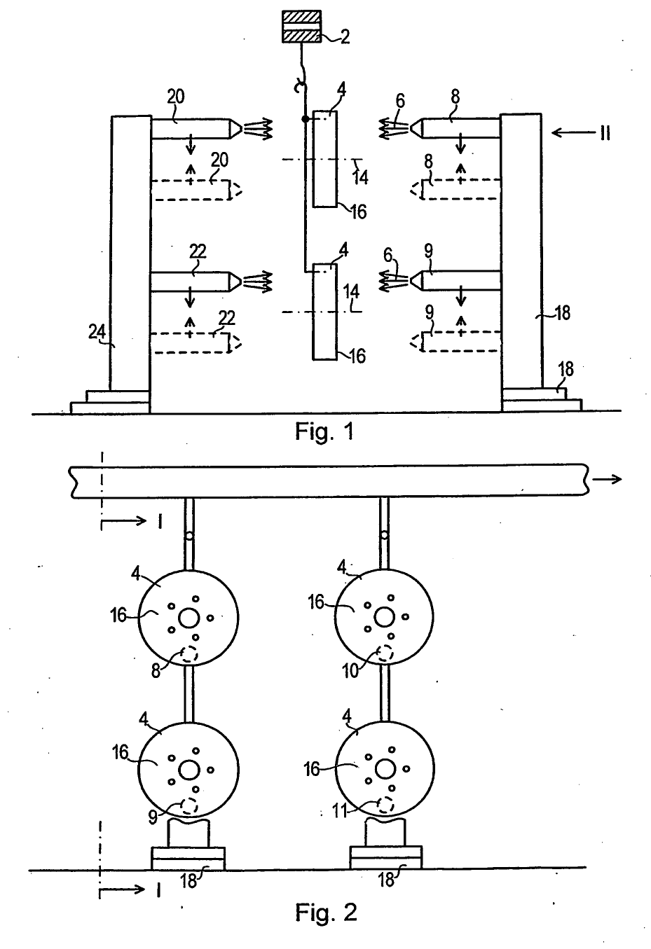

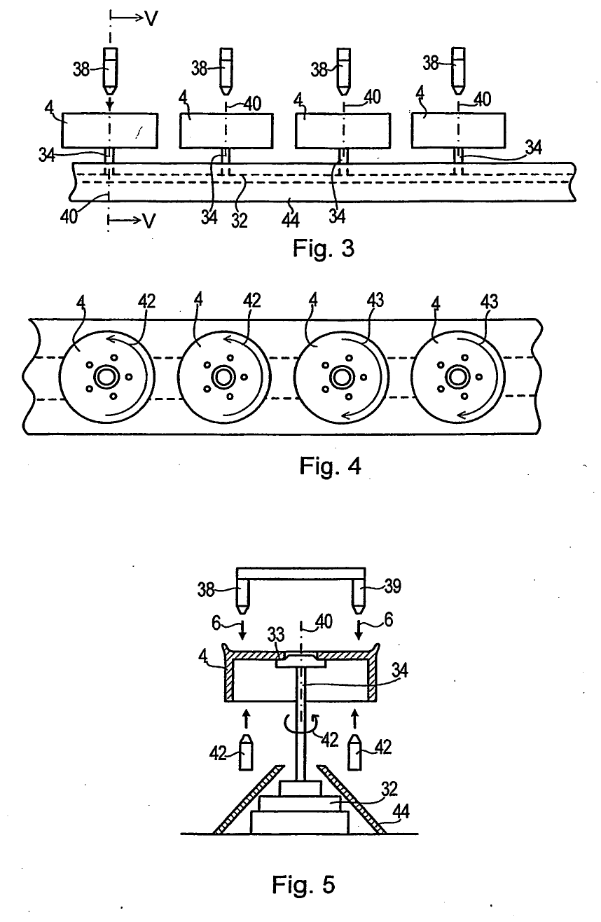

Two procedures are known to spraycoat the front (outer) side of vehicle wheel rims, one of which is illustrated in the appended FIGS. 1 and 2 and the other in the appended FIGS. 3, 4.

In schematic cross-section and in sideview, FIGS. 1 and 2 respectively show a conveyor chain 2 of an overhead conveyor moving two sets each of two superposed rims transversely to the spray jet 6 from spray guns 8, 9, 10, 11 through their spray zone, while the spray guns 8, 9, 10, 11 are moved up and down between the solid lines and the dashed lines shown in FIG. 1. The rims 4 are suspended in such manner from the conveyor chain 2 that their center line 14 is substantially horizontal and that the front outer rim side 16 faces the spray guns 8, 9, 10, 11. Each spray station is fitted with a post 18 along which each time two spray guns 8,9 or 10, 11 are moved up and down by an omitted drive means. The posts 18 are stationary in the longitudinal direction of the conveyor chain 2. In similar manner, the spray guns 20, 22 are displaceable up and down along a post 24 to coat the rear side of the rims 4. This known apparatus incurs the drawback of requiring much powder because a large proportion of this powder is sprayed past the rims. Another drawback is that the rim is unequally covered by the powder coats on it. Rim surfaces projecting onto the spray jet accept more coating powder than rim surfaces recessed from it (shadow side effect). The rim flange receives too much coating powder. Coating powder sprayed on the rim will sink, and therefore the lower rim zone collects more of it than the upper zone. This known procedure offers the advantage that several for instance two rims can be coated simultaneously at each spray zone. Therefore a large number of rims 4 can be coated even at low speeds of the conveyor chain 2. Consequently, after spraying the coating material onto the rim, advantageously an oven baking said deposited material may be short.

FIG. 3 is a sideview, FIG. 4 is a topview, and FIG. 5 is a cross-section along the plane V-V of FIG. 3, of a known spraycoating apparatus spraying coating powder on the front sides of vehicle wheel rims. This apparatus contains a floor conveyor 32 fitted with sequentially mounted motor-rotated spindles 34 each supporting on its upper receiving surface 33 one of the rims 4 of which the front (outer) side points upward. Illustratively four spray stations, each of which is fitted with two spray guns 38, 39 that are mounted diametrically opposite to each other above a rim in irrotational manner and pointing vertically downward in order to spray coating powder onto the upward facing front side 16 of the rim 4 configured underneath while the spindle 24 rotates jointly with the rim 4 about a vertical axis of rotation 40 as regards the first two spray stations in one direction of rotation 42 whereas rotating in the last two spray stations In the opposite direction of rotation 43. The center axis of the rim 4 is vertical and aligned with the axis of rotation 40 of the spindle 34. Further spray devices 42 are used to coat the reverse side of the rims 4. In one embodiment mode, the floor conveyor operates intermittently, stopping while the rims are being coated. In another embodiment mode, the floor conveyor is continuously moving past the stationary spray guns even when the rims are being coated. The drawbacks of these known embodiments are as follows: rapid soiling of the floor conveyor and powder aggregation on the top support surface 33 of the spindles 34 supporting the rims cause the rims 4 to be electrically insulated from electrical ground. As a result the action of the high-voltage electrostatic field typically generated by one or more high voltage electrodes of the spray guns 38, 39 is much reduced. Therefore the floor conveyor 32 and the spindles 34 must be cleaned frequently. To prevent or at least to reduce coating powder penetration into the floor conveyor 32 at the spindles 34, excess air pressure must be generated within a housing 44 protecting said conveyor. Ambient dust settling on the rims 4 degrades coating quality. Because the rims 4 on the floor conveyor 32 can only be configured and coated sequentially, speed of conveyance must be doubled if the same number of rims are to be coated as in the known apparatus of FIGS. 1 and 2. This feature entails the further drawback that an oven baking the coating powder onto the rims 4 must be substantially longer than in the apparatus of FIGS. 1 and 2. On the other hand the apparatus of FIGS. 3 through 5 offers the advantage over that of FIGS. 1 and 2 that it allows the coating powder to better enter rim recesses and offers reduced shadow side effect.

The objective of the present invention is to create apparatus and a method attaining improved coating quality and requiring less coating material. Moreover, while using less equipment, the invention allows simultaneously coating several objects at one coating station, whereby, at low object-conveyor speed, many objects can be coated in a short time, and only a comparatively short oven shall be required to bake the coated objects.

These problems are solved by the present invention by the features of its claim 1.

Accordingly the present invention relates to coating apparatus spraycoating the front/rear sides of circular objects, in particular the front and rear sides of wheels and rims with a coating material while the objects rest on a conveyor, said apparatus being characterized in that it comprises a post fitted with at least one power takeoff element rotatable about an axis of rotation and at least one drive element to rotate to-and-fro the minimum of one power takeoff element about a predetermined angle of rotation; further comprising one spray device holder element per power takeoff element, said holder element comprising a rear holder end as seen in the direction of spraying and irrotationally connected or connectable to the power takeoff element and at least one front holder element end as seen in the direction of spraying and connected or connectable to at least one spray device, the front holder end being radially offset form the axis of rotation, as a result of which, jointly with the spray device and its spray jet, it is rotatable to and fro about the power takeoff elements axis of rotation by the predetermined angle of rotation, the object to be coated on the other hand being configured opposite the spray device and being irrotational.

Moreover the objective of the present invention is attained by a method defined in the claims.

Accordingly the objective of the present invention is also attained by a method to spraycoat the front and rear sides of circular objects, in particular of wheels and rims, with coating material which is sprayed by means of at least one spray device onto the front side while the object is being carried by a conveyor, said method being characterized in that the minimum of one spray device is displaced to and fro along a circular path by a predetermined angle of rotation about an axis of rotation, this spray device being configured at a predetermined radial distance from the axis of rotation, in that the coating material is sprayed by the spray device on the front side of the object during the circular to-and-from motions and in that in the course of spraying, either the minimum of one spray device is moved at the same speed as the objects in the object direction of motion parallel to said objects,or the objects and the minimum of one spray device are kept immobile (stationary) in the direction of conveyance.

The dependent claims define further features of the present invention.

The invention is elucidated below by means of illustrative embodiment modes shown in the appended drawings.

FIG. 1 is a cross-section in the direction of object motion of a powder spraycoating apparatus of the state of the art,

FIG. 2 is a cutaway sideview of the spraycoating apparatus of FIG. 1 of the state of the art,

FIG. 3 is a sideview of another embodiment mode of a powder spraycoating apparatus of the state of the art,

FIG. 4 is a topview of the spraycoating apparatus of FIG. 3,

FIG. 5 is a cross-section in the plane V-V of FIG. 3 of the spraycoating apparatus of the state of the art,

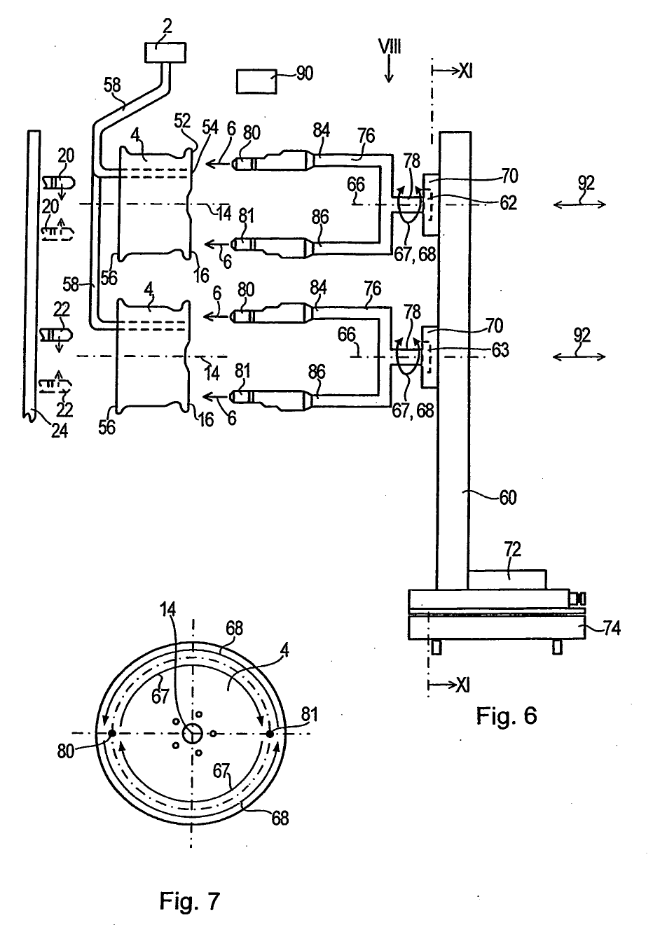

FIG. 6 schematically shows a preferred embodiment mode of a spraycoating apparatus of the present invention to spraycoat front/rear sides of circular objects in the form of vehicle wheel rims, seen in the objects' direction of motion,

FIG. 7 schematically shows a front side elevation of a rim of FIG. 6,

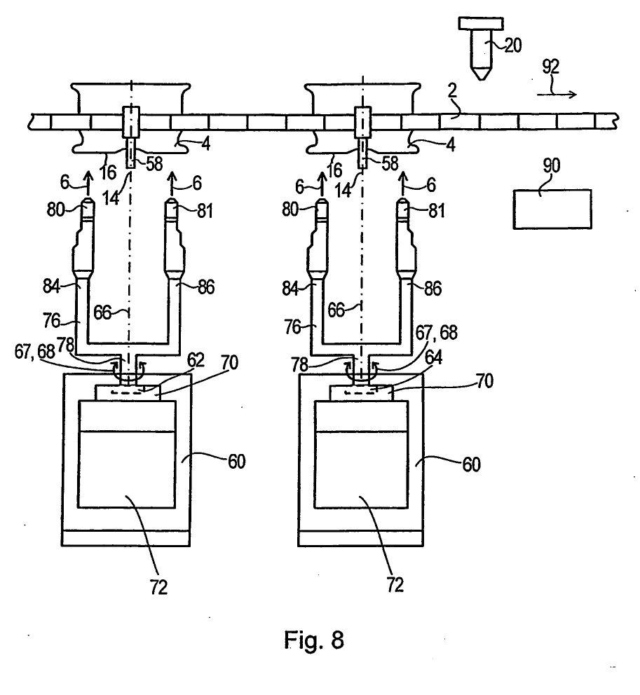

FIG. 8 schematically shows a topview of the spraycoating apparatus of the present invention shown in FIG. 6,

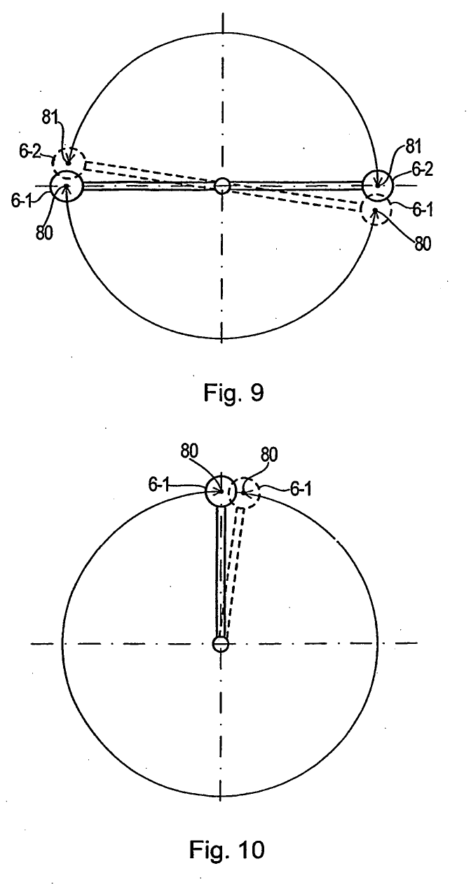

FIG. 9 schematically shows a circular to-and-fro motion over approximately 180° of two spray devices of the invention during spraying,

FIG. 10 schematically shows a circular to-and-fro motion of another embodiment mode of the present invention over approximately 360° during one spraying procedure,

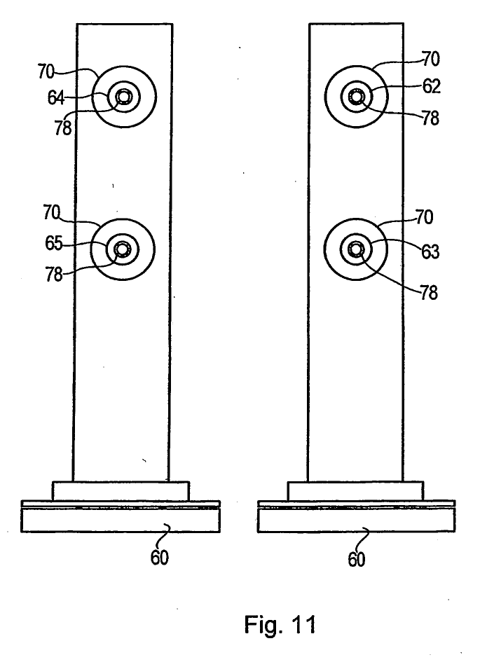

FIG. 11 is a longitudinal section in the plane XI-XI of FIG. 6, and

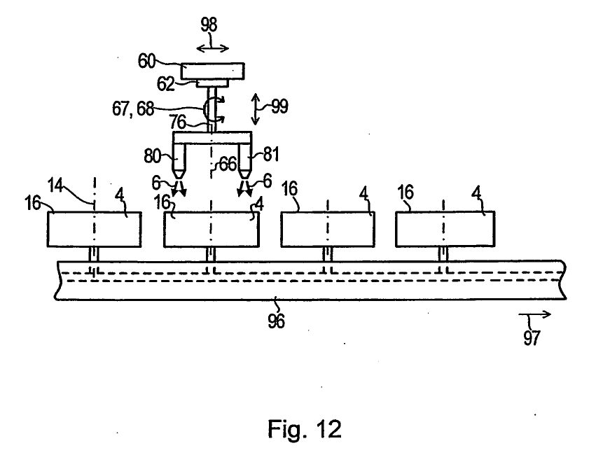

FIG. 12 schematically shows as sideview of a further spraycoating apparatus of the invention.

The present invention relates to spraycoating apparatus to spraycoat the front/rear sides 16 of circular objects 4 with coating material while the objects 4 are moved by a conveyor element of a conveyor in a manner that the center axis 14 of the front/rear sides 16 are substantially horizontal.

Illustratively the objects 4 are arbitrary wheels used for arbitrary purposes, in particular being vehicle wheel rims. The front (outer) side 16 of said rim contains for instance a rim bead seat 52 and a rim flange 54. The spraycoating apparatus of the present invention furthermore allows also coating the rear (opposite) side 56 of the rims 4. However other spraycoating apparatus also may be used because the said rear side does not require the same high quality at the front rim side 18, for instance said rear side merely requiring a spraycoating apparatus shown in FIG. 1 having merely spray devices 20 and 22 which are displaceable up and down at a lift 24. The coating material may be liquid, through preferably it shall be in powder form. Contrary to the case of the various liquid coating material, coating powder is free or ecologically deleterious solvents.

Preferably the conveyor shall be an overhead conveyor illustratively fitted with a conveyance chain 2 from which the rims 4 are suspended for instance by suspension bails 58, as a result of which the center axis 14 of the rims 4 is substantially horizontal. The expression “substantially horizontal” means that the center axis 14 should be aligned horizontally as closely as possible, preferably not being off by more than 20° from the horizontal, otherwise unequal distances from the spray devices coming into play.

The invention comprises at least one, preferably two supports 60 (for instance posts, walls or robots) each supporting one or preferably two or more vertically superposed motor-rotated power takeoff elements 62, 63 respectively 64, 65 each having a substantially horizontal axis of rotation 66 and being rotated to and fro through a maximum angle of rotation of 180° by a drive element as indicated schematically in FIGS. 6 and 8 by a double arrow 67/68. The drive element for the power takeoff elements 62, 63, 64 and 65 may either be each power takeoff element with its own drive element 70 or a joint drive means 72 may be used for every two or more power takeoff elements 62, 63 or 64, 65. The joint drive means 72 illustratively may be mounted on or in a foot element 74 of the support 60. During the spraycoating operation, the axis of rotation 66 is approximately aligned with the center axis 14 of the coated rim 4.

One spray device holder 76 is provided for each power takeoff element 62, 63, 64, 65 and comprises one rear holder end 78 irrotationally connected or connectable to a particular power takeoff element 62, 63, 64, 65 and two front holding ends 84 and 86 that are connected or connectable to a spray device 80, 81. The two front holding ends 84 and 86 of the spray device holder 76 are offset radially and in equal amounts relative to the rear holding end 78 and to the axis of rotation 66 of the associated power takeoff element 62, 63, 64, 65, as a result of which they and the two spray devices 80, 81 can be arcuately rotated to and fro through a maximum angle of rotation of 180° relative to the spray jet 6 of said spray devices about the axis of rotation 66 of the associated power takeoff element 62, 63, 64, 65.

FIG. 7 shows the front side of the rim 4, and schematically the two spray devices 80 and 81 of one of the power takeoff elements 62, 63, 64, 65 and the arrows 67 and 68 denoting the to-and-fro rotations each no more than 180°. Both spray devices 80 and 81 are simultaneously rotated by about 180° in the direction of rotation 97 and then simultaneously by about 180° in the opposite direction of rotation 68.

In a preferred embodiment mode of the present invention, the angle of rotation of the spray devices 80 and 81 about the axis of rotation 66 of the associated power takeoff element 62, 63, 64, 65 is each less than 180° however it is large enough that the spray jet cross-section 6-1 of the spray device 80 and the spray jet cross-section 6-2 of the particular other spray device 81 shall partly overlap in the reversed positions of direction of rotation as shown schematically in FIG. 9. This feature offers the advantage that even in the reversed positions of direction of rotation, the coatings attained shall not be thicker than, but uniformly as thick as at the other sites of the front side 16 over which the spray devices 80 and 81 are being moved.

In the preferred embodiment of the present invention, the centers of the reversed positions of direction of rotation of the spray devices 80 and 81 of each spray device support 76 are situated in a theoretical and approximately horizontal plane situated in the horizontal axis of rotation 66 of the particular associated power takeoff element 62, 63, 64, 65 and being radial to said axis of rotation 66 while subtending an angle with a horizontal direction between 0° and no more than 30°, preferably about 0°. At 0° the two spray devices 80 and 81 are situated next to each other horizontally in the same theoretical plane relative to the center axis of their spray jets 6 as shown in topview in FIG. 8. In corresponding manner, FIG. 9 shows the two spray devices 80 and 81 in an intermediate position rotated 90° on the path of rotational displacement between the two reversal positions of direction of rotation.

The expression “approximately horizontal” in relation to a preferred embodiment of FIG. 9 means that the plane may deviate from the horizontal direction at least in one of the two rotational end positions, or in both the rotational end positions, of the two spray devices 80 and 81 of a spray device holder 76 to an extent that the spray jet cross-sections 6-1 and 6-2 shall at least partly overlap in the reversal positions of direction of rotation.

When coating with coating powders, a few powder particles will always drift down. In order to attain nevertheless the same coating thickness at the lower rim half as on the upper one, less coating powder per unit time may be fed to the spray device 80 or 81 coating the lower rim half than to the spray coating 81 or 80 coating the upper rim half.

If a spray device holder 76 is fitted with only a single spray device 80 (or 81), then the angle of rotation about the horizontal axis of rotation 66 shall be at most 360°; or, in relation to FIG. 10, somewhat less if the sprayjet cross-section 6-1 only partly overlaps itself in the reversal position of the direction of rotation.

As regards the preferred embodiment mode shown in FIGS. 6, 7, 8 and 9, each support 60 comprises two vertically superposed power takeoff elements 62, 63 or 64, 65 having mutually parallel axes of rotation 66, as a result of which two rims 4 can be coated simultaneously at each support 60. Two of the four axes of rotation 66 are situated vertically one above the other and two are horizontally next to each other. Illustratively two rims at one support 60 may be coated a first time and two rims at the other support, that were already coated once, may be coated a second time.

An electronic control unit 90 automatically controls the starts/stops of the circular to-and-fro motions of the power takeoff elements 62, 63, 64, 65 and hence also of the spray devices 80 and 81, further stops/starts of the spraying procedures (coating material spraying) as a function of the speed of conveyance of the conveyor 2 and also depending on a rim being present before the spray devices 80, 81. Preferably the rims 4 are moved by the conveyor 2 at constant speed in the horizontal direction 92 transversely through the spray jet region of the spray devices 80 and 81. While the spray devices 80 and 81 are spraying coating material onto the rim 4, the supports 60 run at the same speed (synchronization) parallel to the conveyor chain of the conveyor 2. At the end of spraying, the supports 60 move parallel to the conveyor chain 18 opposite said chain's direction of motion to return into their initial positions. The control unit 90 also automatically controls this back-and-forth motion of the supports 60. For this purpose the supports 60 are preferably carriages or slides that are displaced by an omitted drive means parallel to the conveyor chain 2.

In order that rims of different widths always be the same distance from the spray device 80 resp. 81, advantageously the following shall be adjustable into different positions; the support 60, and/or the spray devices 80, 81 relative to the support 60, and/or the spray device rest 76 and/or the power takeoff elements 62, 63, 64, 65 each relative to the support 60 transversely to the direction of conveyance 90 of the conveyor chain 2, as indicated schematically in FIG. 6 by the arrows 92. Such adjustments may be automatically controlled by the control unit 90 as a function of the dimensions and shapes of the wheels or rims 4. Manual adjustment also is feasible in a simple mode of implementation.

According to FIGS. 6 and 8, the spray devices 80 and 81 also may be configured in relation to the direction of the spray jets 6 horizontally and parallel to the axis of rotation 66 of the power takeoff element 62, 63, 64, 65, or obliquely to said axis of rotation 66, for instance obliquely outward. In this manner the wheels and rims 4 exhibiting different diameter sizes and furthermore front/rear sides which point radially or obliquely inward can be coated intensively, for instance the rim flange 52. In a preferred embodiment mode, the spray devices can be adjusted in variable manner in their direction of spraying relative to the support 60.

The spray device 80 respectively 81 may be a spray nozzle or a rotary atomizing head or preferably a spray device (spray gun) fitted at its front end with such a spray gun or a rotary atomizing head for coating material and in a rear housing segment comprising fluid conduits for coating material and compressed air and preferably also a high-voltage generator. In many cases an integrated or external high voltage generator is provided to electrostatically charge the coating material using one or more high voltage electrodes so that this material shall be electrostatically attracted by the object (rim 4) at electrical ground.

The spray device holder 76 may be an additional component, or consist of a component, for instance a housing of the spray device 80, 81.

In all embodiment modes of the present invention, the angle of rotation of the rotational displacement of one or more spray devices 80 or 81 about the axis of rotation 66 of a power takeoff element 62, 63, 64 and/or 65 also may be larger than the said 180° or 360°. When said angles of rotation are larger than 360°, in particular larger than 720°, problems may be incurred if supply conduits (coating material, compressed air, electrical cables) of the spray devices 80, 81 are wound onto or unwound from the spray device holders 76, or precautionary measures must be taken.

Two approaches may be used that the spray jets 6 be pointed at the rims 4 but not into the gaps between the rims. The preferred approach is to operate the conveyor chain 2 continuously and to move the supports 60 synchronously with the conveyor chain 2 during each spraying procedure, the supports 60 thereafter being returned opposite the direction of advance of the conveyor chain 2 into their initial positions. In the other approach, the conveyor chain 2 runs intermittently and spraying shall only take place when the conveyor chain 2 is stopped and a rim 4 is in a position opposite the spray devices 80 and 81 which are not displaced in the longitudinal direction of the conveyor chain.

In the embodiment mode of the present invention shown in FIG. 12, a floor conveyor 96 is used instead of an overhead conveyor having a conveyor chain 2, the objects 4 being configured in irrotational manner on said floor conveyor whereby their center axis 14 is vertical. The minimum of one power takeoff element 62 of a support 60 is configured in a way that its axis of rotation shall be vertical. The axis of rotation 66 is kept aligned with the center axis 14 of the particular object to be coated during spraying. For that purpose either the floor conveyor 96 may be moved intermittently in the conveyance direction 97 and the support 60 may be fixed in this direction; or the floor conveyor 96 may move continuously in the conveyance direction and the support 60 may move synchronously with the floor conveyor and then may be moved back after each spraying procedure as indicated by a double arrow 98. Another double arrow 99 schematically shows ways of adjusting the support 60 and/or the spray device holder 76 and or the spray devices 80 and 81 in the longitudinal direction of the axis of rotation 66 of the power takeoff element 62 and hence transversely to the floor conveyor 96. Otherwise the just above cited embodiment mode exhibits the same features and variations as were also discussed in relation to FIGS. 6 through 11.

1. Spraycoating apparatus to spraycoat front and/or rear sides of circular objects, in particular the front/rear sides of wheels and rims, with coating material while the objects are being carried by a conveyor wherein,
by a support comprising at least one power takeoff element rotatable about an axis of rotation and at least one drive element to rotate to and fro the minimum of one power takeoff element through a predetermined angle of rotation; by one spray device holder per power takeoff element, said holder comprising a rear holder end as seen in the direction of spraying which is irrotationally connected or connectable to the power takeoff element and at least one front holder end as seen in the direction of spraying which is connected or connectable to at least one spray device, the front holder end being radially offset relative to the axis of rotation in a manner that, jointly with the spray device and this spray device's spray jet, said front holder end is rotatable to and fro by the predetermined angle of rotation in arcuate manner about the axis of rotation of the power takeoff element while the object to be coated is irrotationally configured opposite the spray device.

2. Spraycoating apparatus as claimed in claim 1, wherein the axis of rotation of the power takeoff element points substantially vertically downward and in that the minimum of one spray device is configured lower than the power takeoff element.

3. Spraycoating apparatus as claimed in claim 1, wherein the axis of rotation of the power takeoff element is configured substantially horizontally and in that the minimum of one spray device is configured farther to the front than the power takeoff element.

4. Spraycoating apparatus as claimed in claim 1, wherein the predetermined angle of rotation is 360° or less than 360° but large enough that the sprayjet cross-section of the spray device at the front side of the object at least partly overlaps itself in the reversal positions of the direction of rotation.

5. Spraycoating apparatus as claimed in claim 1, wherein the spray device holder is fitted with two holder ends each of which is connected or connectable to at least one spray device and in that the two front holder ends are diametrically opposite by about 180° relative to the axis of rotation.

6. Spraycoating apparatus as claimed in claim 5, wherein the predetermined angle of rotation is 180° or less than 180° but large enough that the sprayjet cross-sections of the two spray devices at least partly overlap in the reversal positions of the direction of rotation.

7. Spraycoating apparatus as claimed in claim 5, wherein the centers of the spray jets of the spray devices when in the reversal position of the direction of rotation are situated in a theoretical plane itself also situated in the axis of rotation and being radial relative to the axis of rotation, said theoretical plane subtending an angle between 0° and at most 30° with a horizontal direction.

8. Spraycoating apparatus as claimed in claim 1, wherein the support is fitted with at least two of said power takeoff elements of which the horizontal axes of rotation are configured parallel and vertically mutually superposed.

9. Spraycoating apparatus as claimed in claim 1, wherein the holder is a carriage or a slide horizontally and automatically displaceable synchronously with and parallel to the objects transversely to the axis of rotation as a function of the signals from a control unit.

10. Spraycoating apparatus as claimed in claim 1, wherein the holder is a carriage or a slide able to move to and fro in the axial direction of the axis of rotation.

11. Spraycoating apparatus as claimed in claim 1, wherein the spray device holder is designed to position the minimum of one spray device at different distances from the rotatable power takeoff element.

12. Spraycoating apparatus as claimed in claim 1, wherein the power takeoff element is axially displaceable into various positions along its axis of rotation relative to the support.

13. Spray device as claimed in claim 1, wherein a conveyor to move the objects transversely to the axis of rotation of the minimum of one power takeoff element.

14. Method to spraycoat front/rear sides of circular objects, in particular front/rear sides of wheels and rims, with a coating material which is sprayed by at least one spray device onto the front side while the object is carried by a conveyor wherein
the minimum of one spray device is moved to and from along a circular path about an axis of rotation by a predetermined angle of rotation, the spray device being kept a predetermined, radial distance from the axis of rotation, in that the coating material is sprayed by the minimum of one spray device during the circular to and/or fro motions on the object's front side, and in that during the spraying procedure either the minimum of one spray device is moved at the same speed as the objects in the objects' direction of advance parallel to said objects, or the objects and the minimum of one spray device are kept immobile (stationary) in the direction of advance.

15. Method as claimed in claim 14, wherein the axis of rotation of the takeoff element points vertically downward and the minimum of one spray device is configured lower than the power takeoff element.

16. Method as claimed in claim 14, wherein the axis of rotation of the power takeoff element points horizontally forward and the minimum of one spray device is kept father forward in the direction of spraying than the power takeoff element.

17. Method as claimed in claim 14, wherein two of the spray devices are used, said spray devices being configured diametrically to the axis of rotation of the power takeoff element at mutually opposite sites each radially equally distant from the axis of rotation.

18. Method as claimed in claim 17, wherein the two-and-fro motion is carried out through an angle of rotation less than 180° but at least so large that the spray jet cross-sections of the spray devices partly overlap in the reversal position directions of rotation.

19. Method as claimed in claim 17, wherein the axis of rotation of the power takeoff element is substantially horizontal, in that the centers of the spray jets of the spray devices when in the reversal positions of the direction of rotation are situated in a theoretical plane which is also situated in the axis of rotation and which runs axially relative to the axis of rotation at an angle between 0° and at most 30° to a horizontal direction.

20. Method as claimed in claim 19, wherein during said rotation, less coating material per unit time is sprayed by the particular spray device moving along the lower arc of circle onto the front side of the object than is sprayed onto said side by the particular spray device moving along the upper arc of circle.

21. Method as claimed in claim 14, wherein during the spraying procedure the minimum of one spray device is both rotated circularly to and fro in the above cited manner and simultaneously is moved in the objects' direction of conveyance parallel to and synchronously with the particular object being coated.
